(19) United States
(12) Patent Application Publication
(10) Pub. No.: US 2024/0125459 A1
(43) Pub. Date: Apr. 18, 2024

(54) UNDERWATER LIGHT WITH SWITCHABLE COLOR TEMPERATURE

(71) Applicant: SeaLife Pioneer & Co., Inc. d/b/a Pioneer Research

(72) Inventor: Björn Harms, Cherry Hill, NJ (US)

(21) Appl. No.: 18/489,690

(22) Filed: Oct. 18, 2023

Related U.S. Application Data
(60) Provisional application No. 63/417,042, filed on Oct. 18, 2022.

(51) Int. Cl. F21V 21/00

(52) U.S. Cl. CPC F21V 21/00; F21Y 2113/10

(57) ABSTRACT

An underwater light device is disclosed. The underwater light device comprises at least one source of white light and at least one source of colored light. The light produced by the combination of the at least one source of white light and the at least one source of colored light has an altered color temperature value compared to the light produced by only the at least one source of white light. For example, the combination of the at least one source of white light and the at least one source of colored light may have a color temperature value that is decreased by about 1,000 kelvin to about 2,000 kelvin compared to light produced only by the at least one source of white light.

### PRIORITY

This application claims the benefit of U.S. Provisional 63/417,042, filed Oct. 18, 2022, which is hereby incorporated by reference.

### FIELD OF THE INVENTION

The present invention relates to an underwater device, and, more particularly, to an underwater photo-video light.

### BACKGROUND

Photography and videography require the optimization of optical properties, such as light wavelength of light sources. It is especially challenging to optimize light wavelength in underwater photography and videography due to the depth penetration of the various wavelengths of light. For example, water loses red wavelengths at depths of about 15-30 feet, then orange at depths of about 50 feet, and then yellow wavelengths at about 100 feet. Therefore, underwater lights capable of balancing light output and producing light with altered coloration and temperature are desirable.

### BRIEF SUMMARY

The present embodiments may relate to, inter alia, systems, devices, and methods which provide better quality lighting for photography and videography applications. An underwater light device in accordance with the present disclosure comprises at least one source of white light and at least one source of colored light. The light produced by the combination of the at least one source of white light and the at least one source of colored light has an altered color temperature value compared to the light produced by only the at least one source of white light. For example, the combination of the at least one source of white light and the at least one source of colored light may have a color temperature value that is decreased by about 1,000 kelvin to about 2,000 kelvin compared to light produced only by the at least one source of white light.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with an embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 is a front perspective view of an underwater photo-video light in accordance with an embodiment of the present disclosure.

FIG. 2 is a front view of the underwater photo-video light of FIG. 1.

FIG. 3 is a front perspective view showing an underwater photo-video light in accordance with another embodiment of the present disclosure.

FIG. 4 is a front view of the underwater photo-video light of FIG. 3.

FIGS. 5A-5C are intensity graphs for white light, red light, and a combination of white light and red light, respectively.

### DETAILED DESCRIPTION

Reference will now be made in detail to the preferred embodiments of the present invention, examples of which are illustrated in the accompanying drawings. While the present invention will be described in conjunction with the preferred embodiments, it will be understood that they are not intended to limit the present invention to these embodiments. On the contrary, the present invention is intended to cover alternatives, modifications and equivalents, which may be included within the spirit and scope of the present invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

Some portions of the detailed descriptions which follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, etc., is conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proved convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “implementing”, “outputting”, “generating”, “receiving”, “transmitting”, “determining”, “using” or the like, refer to the actions and processes of a computer system, or similar electronic device including a personal digital assistant (PDA). The computer system or similar electronic computing device manipulates and transforms data represented as physical (electronic) quantities within the computer system's registers and memories into other data similarly represented as physical quantities within the computer system memories or registers or other such information storage, transmission, or display devices.

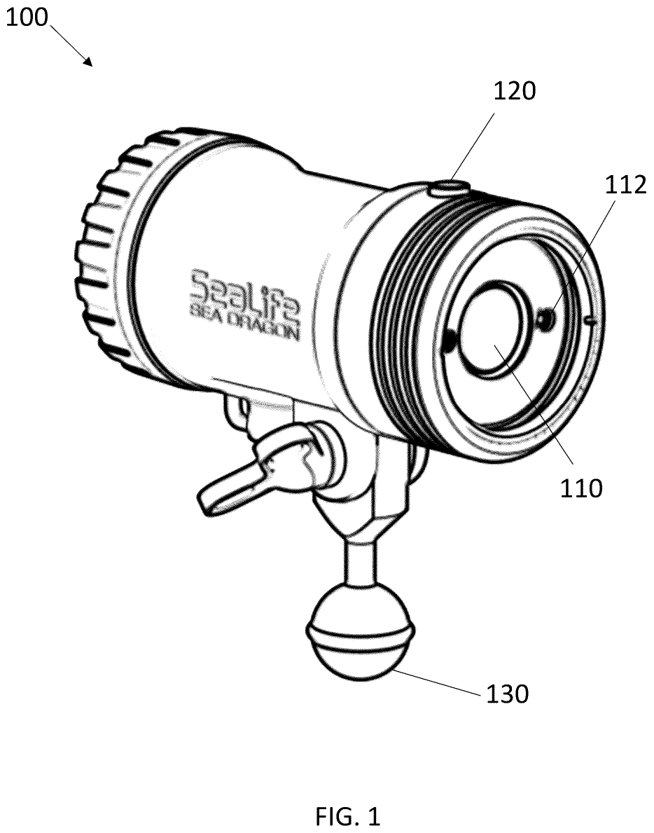

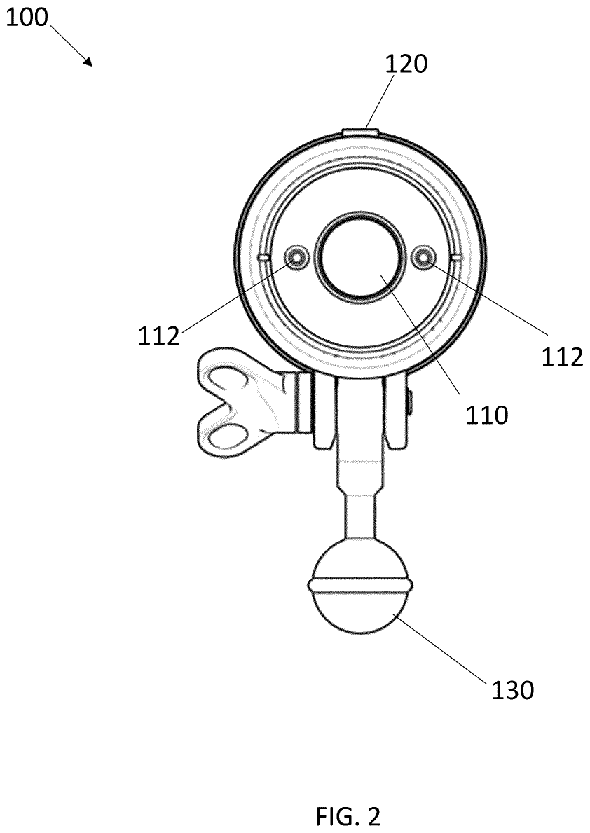

FIGS. 1 and 2 illustrate a photo-video light 100 in accordance with an embodiment of the present disclosure. In some embodiments, photo-video light 100 is configured for underwater use. For example, photo-video light 100 may be configured to be coupled to an underwater device, such as an underwater case designed for smartphones/tablets. For example, photo-video light 100 may be configured to be mounted on a camera or case designed to hold a camera, smartphone, tablet, or other device. In some embodiments, photo-video light 100 may comprise an element configured to mate with an underwater case. For example, photo-video light 100 may comprise a ball head 130 configured to mate with a socket of a camera or case. However, the ball and socket embodiment is by way of example only, and photo-video light 100 may comprise various other elements for coupling with an underwater case.

Photo-video light 100 comprises at least one white light source 110 and at least one colored light source 112. It was discovered that a combination of a white light source and one or more colored light sources could be used to balance light output and produce light with altered coloration and temperature compared to a white light source alone. The combination of the white light and the colored light can be used to quickly adjust the color temperature of the emitting light, which is particularly useful to underwater photographers and/or videographers to achieve a desired color effect.

In the embodiment illustrated in FIGS. 1 and 2, photo-video light 100 comprises one white light source 110 and two colored light sources 112. However, photo-video light 100 may comprise more white light sources 110 and more or less colored light sources 112. In some embodiments, the at least one white light source 110 comprises a white LED and the at least one colored light source 112 comprises color LEDs. The at least one colored light source 112 is configured to produce light in a color selected from the group consisting of red, amber, yellow, orange, and/or combinations thereof. In some embodiments, the at least one colored light source 112 is configured to produce red light. For example, in some embodiments, the at least one colored light source 112 comprises a red LED. In some embodiments, such as the embodiment illustrated in FIGS. 1 and 2, there is a plurality of colored light sources 112. Each of the plurality of colored light sources may produce the same color of light or different colors of light. For example, in some embodiments a first colored light source may be configured to produce red light a second colored light source may be configured to produce red light. In other embodiments, a first colored light source may be configured to produce red light and a second colored light source may configured to produce amber light.

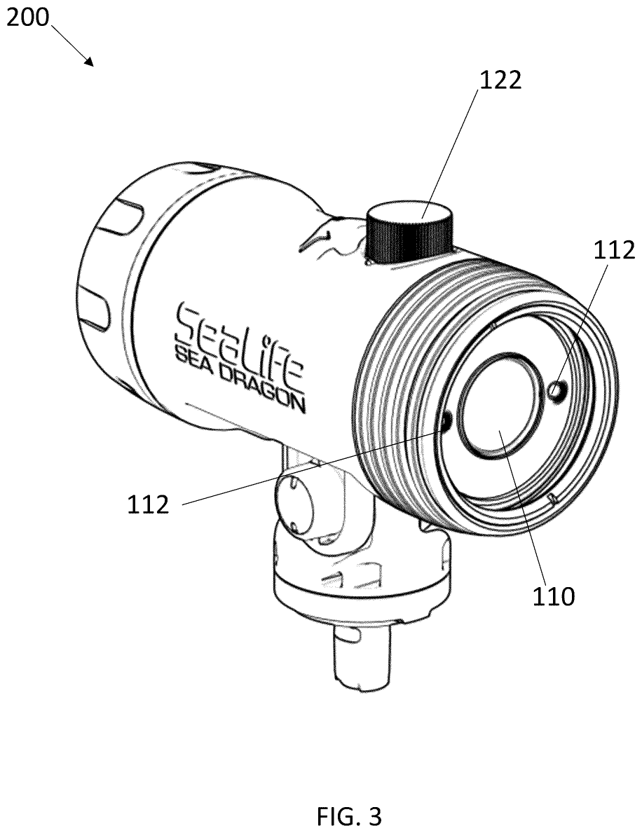

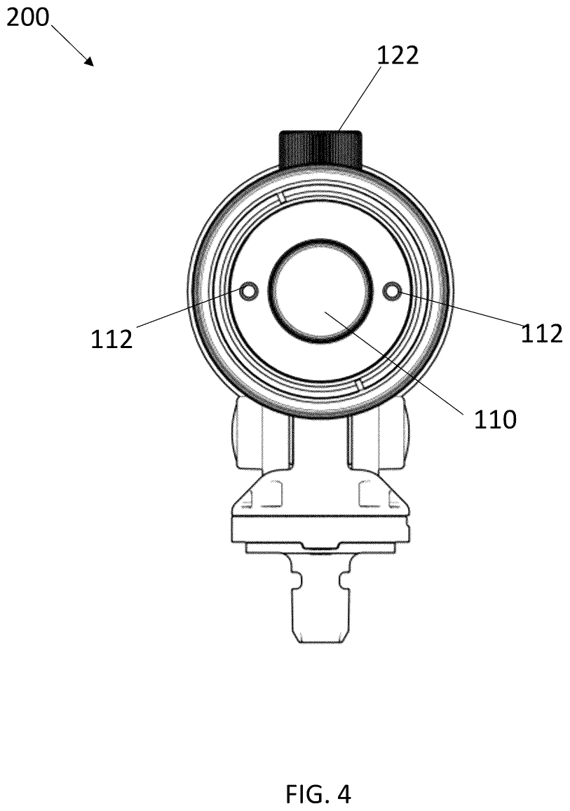

Photo-video light 100 includes at least one input components 120. In the embodiment illustrated in FIGS. 1 and 2, the at least one input component 120 comprises a push button. However, the at least one input component 120 may comprise a rotating dial, a rotating dial with push-button function, a sliding switch, or the like, as discussed in more detail with regards to FIGS. 3 and 4. The at least one input component 120 is configured to power the at least one white light source 110 and the at least one colored light source 112 on and off. In some embodiments, the at least one input component 120 may be configured to switch between white light only (i.e., white light source 110 powered on only), colored light only (i.e., colored light source(s) 112 powered on only), and/or a combination of white light and colored light (i.e., white light source 110 and colored light source(s) 112 both powered on at same time). The switching between light modes (e.g., white light only mode, colored light only mode, and/or a combination of white light and colored light mode) enables a photographer and/or videographer to select a desired lighting effect. The colored light only mode, when used underwater, may be used for a “stealth mode”. For example, if the at least one colored light source 112 produces red light, when the light is in red-light only mode, the red light may go unnoticed by sea creatures due to the naturally occurring filter effect water induces on red light at depths of 15-30 feet.

In some embodiments, pushing and holding input component 120 down for a predetermined period of time (e.g., 2 seconds) powers the light ON and OFF. In some embodiments, when in a power ON state, pushing and releasing input component 120 switches between different modes, each mode having a different brightness and/or color temperature. For example, in some embodiments, a first mode comprises white light with a luminous flux of about 5,000 lumens and a color temperature of about 5,000 kelvin (default setting when powering on light); a second mode comprises white light with a luminous flux of about 5,000 lumens plus a color boost (e.g., a combination of white and colored light) resulting in light with a color temperature of about 3,700 kelvin; a third mode comprises white light with a luminous flux of about 6,000 lumens and a color temperature of about 5,000 kelvin; a fourth mode comprises white light with a luminous flux of about 6,000 lumens plus a color boost (e.g., a combination of white and colored light) resulting in light with a color temperature of about 4,000 kelvin; a fifth mode comprises white light with a luminous flux of about 3,000 lumens and a color temperature of about 5,000 kelvin; a sixth mode comprises white light with a luminous flux of about 3,000 lumens plus a color boost (e.g., a combination of white and colored light) resulting in light with a color temperature of about 2,7000 kelvin; and a seventh mode comprises white light with a luminous flux of about 1,500 lumens and a color temperature of about 5,000 kelvin. The luminous flux and color temperatures of the different modes are by way of example only, and the different modes may have various other luminous flux and/or color temperatures. In some embodiments, the at least one white light source 110 may be configured to produce light at about 6,000 lumen for 2 minutes at which time it automatically adjusts to a lower lumen output to conserve power.

In some embodiments, the brightness (e.g., lumen output) and/or color temperature (e.g., kelvin output) of the at least one white light source 110 and the at least one colored light source 112 are fixed (e.g., not adjustable). For example, in some embodiments the at least one white light source 110 is configured to produce light at about 5,000 kelvin and the at least one colored light source 112 is configured to produce light which, when combined with the white light, results a warm color temperature of about 3,700 kelvin.

FIGS. 3 and 4 illustrate a photo-video light 200 in accordance with another embodiment of the present disclosure. Similar to photo-video light described above with respect to FIGS. 1 and 2, photo-video light 200 comprises at least one white light source 110 and at least one colored light source 112. Photo-video light 200 may comprise some or all of the components and functionality described above with regards to photo-video light 100 of FIGS. 1 and 2.

Photo-video light 200 comprises at least one adjustable input component 122 configured to adjust the brightness (e.g., lumen output) and/or color temperature (e.g., kelvin output) of the at least one white light source 110 and/or the at least one colored light source 112. In these embodiments, the brightness and/or color temperature of the at least one white light source 110 and the at least one colored light source 112 are variable. In the embodiment illustrated in FIGS. 3 and 4, the at least one adjustable input component 122 comprises a rotatable dial. This enables a user to adjust the brightness and/or color temperature of the white light and/or colored light to achieve the desired effect. For example, in some embodiments, rotating adjustable input component 122 in a first direction (e.g., clockwise) powers the light ON and increases brightness (e.g., lumen output) of the at least one white light source 110 and rotating adjustable input component 122 in a second direction (e.g., counter-clockwise) powers the light OFF and decreases brightness (e.g., lumen output) of the at least one white light source 110. In some embodiments, the at least one white light source 110 is configured to produce light with a luminous flux of about 1,500 lumens to 6,000 lumens. In some embodiments, adjustable input component 122 is further configured to push and release, where pushing and releasing adjustable input component 122 activates color boost (e.g., turns on the at least one colored light source 112) which results in a warmer light. In some embodiments, by rotating the dial, the color temperature may be adjusted from about 2,700 kelvin to about 5,000 kelvin when in color boost mode.

In some embodiments, the at least one white light source 110 may be configured to produce light at about 6,000 lumens for only predetermined period of time (e.g., 2 minutes) at which time it automatically adjusts to a lower lumen output to conserve power.

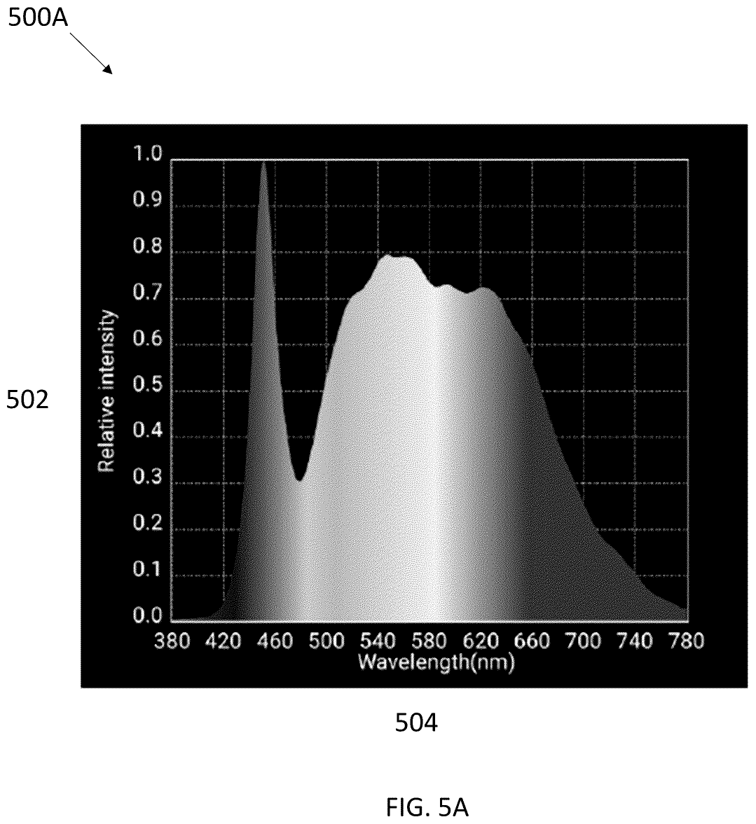

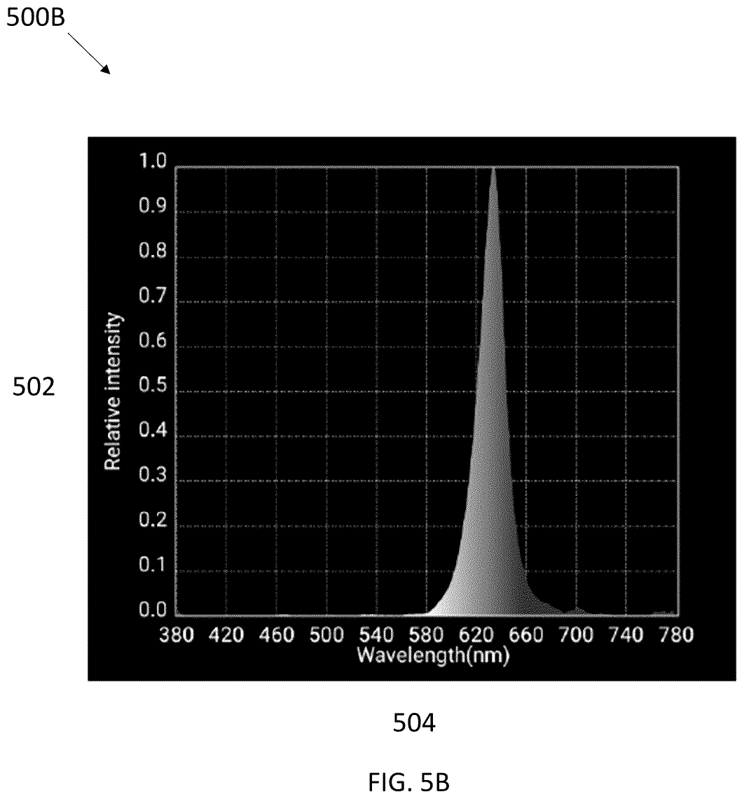

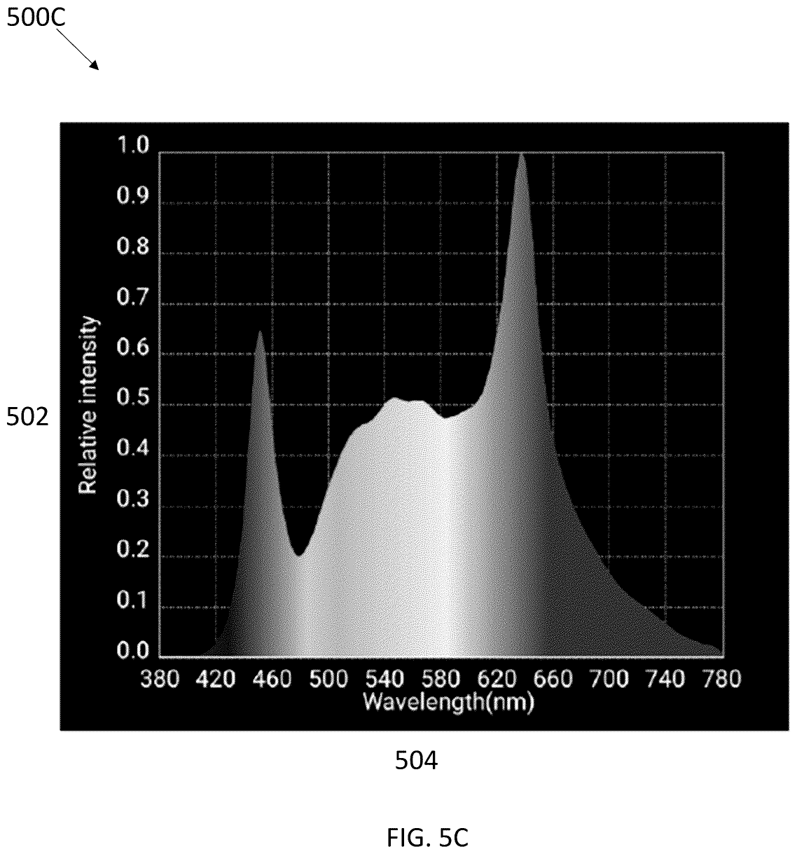

FIG. 5A is a graph 500A showing relative intensity 502 of white LEDs as a function of wavelength (nm) 504. White LEDs emit white light, typically in the visible light wavelength range of 400 nm to 700 nm, producing a color temperature in the 4,500 to 6,000 kelvin range, as shown in FIG. 5A.

FIG. 5B is a graph 500B showing relative intensity 502 of red LEDs as a function of wavelength (nm) 504. Red LEDs emit red light in the visible light wavelength range of 600 nm to 650 nm, as shown in FIG. 5B. A red colored light is not normally expressed in terms of color temperature value.

FIG. 5C is a graph 500C showing relative intensity 502 of a combination of both white and red LEDs as a function of wavelength (nm) 504. When both white and red LEDs are powered on, the combined wavelengths produce a “warmer” light in the color temperature in the range of 3,500 to 5,000 kelvin, depending on the degree of power emitted by either light, as illustrated in FIG. 5C. In other words, adding the red light to varying degrees will reduce the color temperature of the white light by about 1,000 kelvin to about 2,000 kelvin. Combining white and red LEDs to produce a warmer color temperature is particularly useful in underwater photography and videography because, as described above, water absorbs the red wavelengths before any other colored wavelengths. However, colored light sources may be configured to produce colored light in a color selected from the group consisting of red, amber, yellow, orange, and combinations thereof.

Those of skill in the art will appreciate that the herein described apparatuses, engines, devices, systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the disclosure, any appended claims and any equivalents thereto.

In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

1. A light device comprising:
at least one source of white light; and
at least one source of colored light;
wherein the light produced by the combination of the at least one source of white light and the at least one source of colored light has an altered color temperature value compared to the light produced by only the at least one source of white light.

2. The light device of claim 1, wherein the at least one source of colored light is configured to produce colored light in a color selected from the group consisting of red, amber, yellow, orange, and combinations thereof.

3. The light device of claim 1, wherein the at least one source of colored light is configured to produce colored light at a wavelength in a range of from about 600 nm to 650 nm.

4. The light device of claim 1, wherein the at least one source of colored light comprises at least two sources of colored light, wherein the at least two sources of colored light are each configured to produce colored light in a color selected from the group consisting of red, amber, yellow, orange, and combinations thereof.

5. The light device of claim 1, wherein the light produced by the combination of the at least one source of white light and the at least one source of colored light has a color temperature of about 3,5000 kelvin to about 5,000 kelvin.

6. The light device of claim 1, wherein the light produced by the combination of the at least one source of white light and the at least one source of colored light has a color temperature value that is altered by about 1,000 kelvin to about 2,000 kelvin compared to the light produced only by the at least one source of white light.

7. The light device of claim 1, wherein the light produced by the combination of the at least one source of white light and the at least one source of colored light has a color temperature value that is decreased by about 1,000 kelvin to about 2,000 kelvin compared to the light produced only by the at least one source of white light.

8. The light device of claim 1, further comprising at least one input component, the input component configured to switch between different modes of the light device.

9. The light device of claim 8, wherein the at least one input component is configured to switch between a first mode comprising white light only and a second mode comprising a combination of white light and colored light.

10. The light device of claim 9, wherein the at least one input component is configured to switch between the first mode, the second mode, and a third mode comprising colored light only.

11. The light device of claim 9, wherein the at least one input component is further configured to adjust at least one of a brightness or a color temperature of at least one of the at least one white light source or the at least one colored light source.

12. The light device of claim 1, wherein at least one of a brightness or a color temperature of the light produced by the at least one source of white light is a fixed.

13. The light device of claim 12, wherein at least one of a brightness or a color temperature of the light produced by the at least one source of colored light is a fixed.

14. The light device of claim 1, wherein at least one of a brightness or a color temperature of the light produced by the at least one source of white light is variable.

15. The light device of claim 14, wherein at least one of a brightness or a color temperature produced by the at least one source of colored light is variable.

16. The light device of claim 1, wherein the at least one source of white light produces light at about 1,500 lumen to about 6,000 lumen.

17. The light device of claim 1, wherein the at least one source of white light produces light at about 5,000 lumen.

18. The light device of claim 1, wherein the light device is configured for underwater use.

19. The light device of claim 1, wherein the light device is configured to couple with a camera.

20. The light device of claim 1, wherein the light device is configured to couple to a case designed to fit a smart device.
